(19) United States
(12) Patent Application Publication
(10) Pub. No.: US 2009/0175363 A1
(43) Pub. Date: Jul. 9, 2009

(54) Assignment of sub-channels to channels in a multi transmission-channel system

(76) Inventors: Ari Hottinen, Espoo (FI); Tiina Heikkinen, Kirkkonummi (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/921,136

(22) PCT Filed: May 27, 2005
(86) PCT No.: PCT/IB2005/001857

§ 371 Date: Jan. 2, 2009

(51) Int. Cl. H04L 27/28

(52) U.S. Cl. 375/260

(57) ABSTRACT

A method of allocating a set of sub-channels to a plurality of transmission channels in a multi transmission-channel system comprising the steps of; mapping a first, non-zero, set of sub-channels to a first transmission channel, mapping a second, non-zero, set of sub-channels to a second transmission channel, wherein at least one sub-channel of the first set and at least one sub-channel of the second set are allocated to one receiving unit.

### CROSS REFERENCE TO RELATED APPLICATION

This application is the U.S. National Stage of International Application Number PCT/IB05/001857 filed on May 27, 2005 which was published in English on Nov. 30, 2006 under International Publication Number WO 2006/126038.

### FIELD OF THE INVENTION

Embodiments of the present invention relate to assignment of sub-channels to channels in a multi transmission-channel system. In particular, they relate to assignment of sub-channels to channels in a multi transmission-channel system where each transmission channel is associated with a different antenna.

### BACKGROUND TO THE INVENTION

The present invention may be used for example in multi channel OFDM systems such as WiFi, WiMax, 3G, and 4G systems. The invention may also be used in OFDMA systems or any other systems where the transmission channels between two physical locations are at least orthogonal or quasi-orthogonal, or contain orthogonal or quasi-orthogonal sub-channels, or where they may approximated as such. Quasi-orthogonality may be realized by selection of sub-channels, signaling waveforms, selection of modulation and coding parameters, selection of other transmission resources such as antennas or beams, or combination thereof.

The invention addresses the problem of assigning sub-channels to transmission channels in a manner which optimizes the performance or some other desired objective (such as utility) of the system whilst at the same time prevents the transmission method from violating transmission constraints, for example, overloading any of the power amplifiers, transmission antennas or transmission channels, or conversely, while ensuring that certain desired constraints (such as delay, throughput) are satisfied.

### BRIEF DESCRIPTION OF THE INVENTION

According to one embodiment of the invention there is provided a method of allocating a set of sub-channels to a plurality of transmission channels in a multi transmission-channel system comprising; mapping a first, non-zero, set of sub-channels to a first transmission channel, mapping a second, non-zero, set of sub-channels to a second transmission channel, wherein at least one sub-channel of the first set and at least one sub-channel of the second set are allocated to one receiving unit.

Sending sub-channels from two or more transmission channels to one receiver improves the performance of the system as with multi-path interference on one or more channels does not prevent communication due to excessive interference, but simultaneously, diversity or received signal power is increased.

According to one embodiment of the invention there is also provided a node in a telecommunications network comprising means for allocating a set of sub-channels to a plurality of transmission channels in a multi transmission-channel system comprising; means for mapping a first, non-zero, set of sub-channels to a first transmission channel and means for mapping a second, non-zero, set of sub-channels to a second transmission channel, wherein at least one sub-channel of the first set and at least one sub-channel of the second set are allocated to one receiving unit.

A node may be for example a transmitter or a receiver or any element in the core network. Each node may comprise a processor and a memory. The memory may store computer program instructions which, when loaded into the processor, control the functions of the node.

According to one embodiment of the invention there is also provided a computer program comprising program instructions for controlling the allocation of a set of sub-channels to a plurality of transmission channels in a multi transmission-channel system which, when loaded into a processor, provide; means for mapping a first, non-zero, set of sub-channels to a first transmission channel and means for mapping a second, non-zero, set of sub-channels to a second transmission channel, wherein at least one sub-channel of the first set and at least one sub-channel of the second set are allocated to one receiving unit.

According to one embodiment of the invention there is also provided a physical entity embodying the computer program as described above. The physical entity may be, for example, a memory or a record carrier.

According to a second embodiment of the present invention there is provided a method of allocating each of a set of sub-channels to a plurality of transmission channels in a multi transmission-channel system, wherein each of the transmission channels of the multi transmission-channel system has at least one sub-channel assigned thereto.

Having at least one sub-channel assigned to every transmission channel means that the sub-channels are allocated more evenly between the channels and prevents any overloading of the power amplifiers that feed the transmission channel. This also reduces the peak-to-average ratio of the signal which improves the efficiency of the amplifiers. This also allows the transmitter to control the total signal power transmitted by each of the transmission channels. The number of sub-channels to be assigned to the transmission channels may be different for each transmission channel, and the number may be controlled by an internal or an external control signal.

According to the second embodiment of this invention there is also provided a node in a telecommunications network comprising means for allocating each of a set of sub-channels to a plurality of transmission channels in a multi transmission-channel system comprising, means for assigning at least one sub-channel to each of the transmission channels of the multi transmission-channel system.

According to the second embodiment of this invention there is also provided a computer program comprising program instructions for controlling the allocation of each of a set of sub-channels to a plurality of transmission channels in a multi transmission-channel system, which, when loaded into a processor, provides means for assigning at least one sub-channel to each of the transmission channels of the multi transmission-channel system.

According to the second embodiment of the invention there is also provided a physical entity embodying the computer program as described above. The physical entity may be, for example, a memory or a record carrier.

According to a third embodiment of the invention there is provided a method of allocating a set of sub-channels to a plurality of transmission channels in a multi transmission-channel system comprising; mapping a first, non-zero, set of sub-channels to a first transmission channel, mapping a second, non-zero, set of sub-channels to a second transmission channel, wherein the sub-channels are assigned to the transmission channels to optimise a performance indicator of the multi transmission-channel system.

This provides the advantage that the performance of the system is optimised without overloading any of the power amplifiers or transmission channels.

Preferably the transmitter obtains values of the performance indicator for each possible sub-channel and transmission channel combination. There are a number of performance indicators which could be used for example, the throughput, the signal-to-noise ratio, the transmit power required for a given quality of signal or an error measure, for example, frame or packet error measure. The transmission channel may constitute a multi-antenna or multi-beam transmitter where each sub-channel is transmitted from one or multiple antennas. Furthermore, the transmission channel or channels may include transmitting all sub-channels from all antennas or beams, but the at least one transmission resource, the transmitted information symbols, or the physical radio channel is different for at least two sub-channels.

When determining the assignment of sub-channels to transmission channels more than one performance indicator can be considered at any one time. For example the optimization procedure may take into account both reducing the transmitted power and increasing the throughput. The optimization procedure may take into account the realized, desired or tolerated delay for the given service. The performance indicators may be combinations of different measurements or different criteria.

According to the third embodiment of this invention there is also provided a node in a telecommunications network comprising means for allocating a set of sub-channels to a plurality of transmission channels in a multi transmission-channel system comprising; means for mapping a first, non-zero, set of sub-channels to a first transmission channel and means for mapping a second, non-zero, set of sub-channels to a second transmission channel, wherein the sub-channels are assigned to the transmission channels to optimise a performance indicator of the multi transmission-channel system.

According to the third embodiment of this invention there is also provided a computer program comprising program instructions for controlling the allocation of a set of sub-channels to a plurality of transmission channels in a multi transmission-channel system which when loaded into a processor provides; means for mapping a first, non-zero, set of sub-channels to a first transmission channel and, means for mapping a second, non-zero, set of sub-channels to a second transmission channel, wherein the sub-channels are assigned to the transmission channels to optimise a performance indicator of the multi transmission-channel system.

According to the third embodiment of the invention there is also provided a physical entity embodying the computer program as described above. The physical entity may be, for example, a memory or a record carrier.

According to a fourth embodiment of the invention there is provided a method of allocating a set of sub-channels to channels in a multi transmission-channel system comprising: allocating the set of sub-channels to the transmission channels, if a first sub-channel has a low performance indicator value when allocated to a first transmission channel, reassigning the first sub-channel to a second transmission channel with a higher performance indicator, increasing the priority of the first channel for the next scheduling or assignment interval.

This provides the advantage that it optimises the performance of the system for each allocation interval.

According to the fourth embodiment of this invention there is also provided a node in a telecommunications network comprising means for allocating a set of sub-channels to channels in a multi transmission-channel system comprising; means for allocating the set of sub-channels to the transmission channels, means for reassigning the first sub-channel to a second transmission channel with a satisfactory performance indicator, if a first sub-channel has an unsatisfactory performance indicator value when allocated to a first transmission channel and means for increasing the priority of the first channel for the next scheduling interval.

According to the fourth embodiment of this invention there is also provided a computer program comprising program instructions for controlling the allocation of a set of sub-channels to channels in a multi transmission-channel system which when loaded into a processor provide; means for allocating the set of sub-channels to the transmission channels, means for reassigning the first sub-channel to a second transmission channel with a satisfactory performance indicator, if a first sub-channel has an unsatisfactory performance indicator value when allocated to a first transmission channel and means for increasing the priority of the first channel for the next scheduling interval.

According to the fourth embodiment of the invention there is also provided a physical entity embodying the computer program as described above. The physical entity may be, for example, a memory or a record carrier.

According to a fifth embodiment of the present invention there is provided a method of allocating a set of sub-channels to channels in a multi transmission-channel system using a utility/cost matrix comprising modifying the cost/utility matrix in at least one dimension; and computing subchannel allocations using the modified cost/utility matrix.

The cost/utility matrix may be modified by, for example, reducing the dimensionality of the matrix in two dimensions or increasing the dimensionality of the matrix to create a square matrix. The dimensionality of the matrix may be increased by copying rows or columns. Some elements of the matrix may be copied more times than other elements.

A further sub-channel allocation may be computed by using a different cost/utility matrix having a different dimensionality.

Information relating to the sub-channel assignments to a transmitter and/or a receiver may be transmitted.

According to the fifth embodiment of this invention there is also provided a node in a telecommunications network comprising means for allocating a set of sub-channels to channels in a multi transmission-channel system using a utility/cost matrix comprising; means for modifying the cost/utility matrix in at least one dimension; and means for computing sub-channel allocations using the modified cost/utility matrix.

According to the fifth embodiment of this invention there is also provided a computer program comprising program instructions for controlling the allocation of a set of sub-channels to channels in a multi transmission-channel system using a utility/cost matrix which, when loaded into a processor, provide means for modifying the cost/utility matrix in at least one dimension; and means for computing sub-channel allocations using the modified cost/utility matrix.

According to the fifth embodiment of this invention there is also provided a physical entity embodying the computer program as described above.

### BRIEF DESCRIPTION OF THE DRAWINGS

For a better understanding of the present invention reference will now be made by way of example only to the accompanying drawings in which:

FIG. 1 illustrates a transmitter according to a first embodiment of the invention

FIG. 2 illustrates a method of assigning sub-channels to transmission channels according to a first embodiment of the invention

FIG. 3 illustrates a method of assigning sub-channels to transmission channels according to a second embodiment of the invention.

### DETAILED DESCRIPTION OF EMBODIMENTS OF THE INVENTION

The Figures illustrate a method of allocating a set of sub-channels 3 to a plurality of transmission channels 5 in a multi transmission-channel system 1 comprising the steps (actions) of; mapping a first, non-zero, set of sub-channels 3a to a first transmission channel 5a, mapping a second, non-zero, set of sub-channels 3b to a second transmission channel 5b, wherein at least one sub-channel of the first set 3a and at least one sub-channel of the second set 3b are allocated to one receiving unit 7.

In the embodiments shown in the figures the multi transmission channel system 1 is a multi antenna system. Each antenna 5 is a transmission channel. In other embodiments the transmission channels may be anything along which a signal can be transmitted, for example a beam, an antenna or a radiation pattern or a collection of antennas or beams, or a modulation matrix transmitted over multi-antenna transmission resources, parameters of the modulation matrix (symbol alphabet, power, bit loading). The transmission channel properties and transmission resource allocation both affect the selected performance measure and thus may affect the allocation of sub-channels to transmission channels.

A sub-channel is a series of symbols or information which a transmission channel can be separated into. A sub-channel may be formed as a linear combination of different types of sub-channels or of different sub-channels. Examples of sub-channel types include, different frequencies, spreading codes, wavelets, basis vectors of discrete Fourier transforms, OFDM subcarriers, time slots and so on. Information contained in sub-channels may be modulated, coded, power controlled, rate controlled or be subject to controllable modulation and coding.

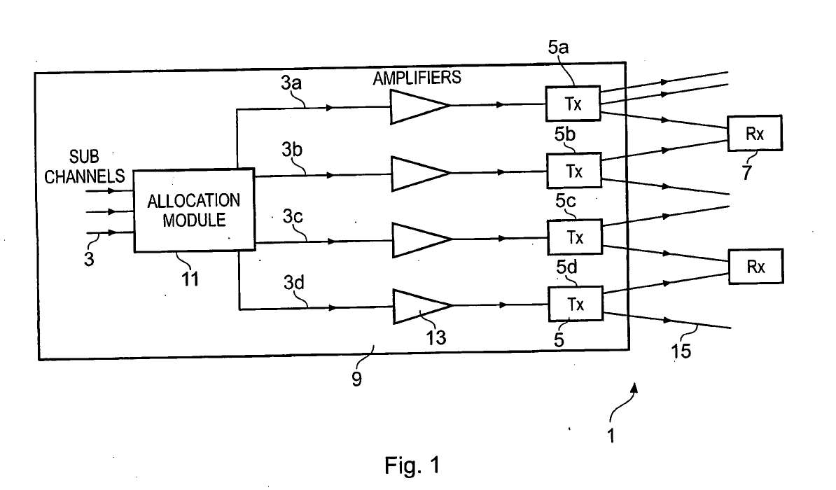

The transmitter unit 9 illustrated in FIG. 1 comprises an allocation module 11 and plurality of antennas 5a, 5b . . . and respective power amplifiers 13a, 13b . . . . The signals 15 transmitted by the antennas 5 are received by the receiving units 7a and 7b. The transmitter unit 9 may be implemented in a base station or in a mobile station of a communications system.

The transmitter unit 9 may also comprise a processor and a memory. The memory may store computer program instructions which, when loaded into the processor, control the functions of the transmitter unit 9 and in particular the allocation module 11.

A set of sub-channels 3 are allocated by the allocation module 11.

The allocation module 11 allocates each of the sub-channels 3 to one of the transmission channels 5a, 5b . . . . In this embodiment the sub-channels 3 are assigned to the transmission channels 5 in a way which uses information about each transmission channel 5 to optimize the performance of the system 1 but is subject to constraints on the number of sub-channels 3 which can be assigned to each channel 5.

There are several different variables which can be measured to give an indication of the performance (or the utility) of the system. The performance may relate to the actual current performance of the system or a virtual performance for a virtual assignment of the sub-channels 3 to the transmission channels 5. These variables include the throughput, the signal to noise ratio, the transmitted power required for a given quality of service or an error measure. Different performance measures may lead to different optimal allocations.

More than one performance measure may be used to assign the sub-channels 3 to the transmission channels 5. For example, the performance indicator may be a combination of the signal to noise ratio and the throughput.

The performance measures may be obtained from a feedback channel or from measurements made when channel reciprocity holds.

The constraints on the number of sub-channels assigned to each antenna 5 prevents uneven loading of the power amplifiers 13 and improves the peak-to-average ratio (PAR) of each transmitted signal 15. The PAR is the ratio of the maximum magnitude of a signal parameter to its time averaged value. The PAR can be determined for many signal parameters including, voltage, current, power and frequency. A small PAR improves the efficiency of the amplifiers and allows for easier design of the amplifiers. The PAR optimal assignment solution is to have an equal number of sub-channels assigned to each channel. However the PAR optimal assignment of sub-channels may not be performance optimal.

In some systems it may be beneficial to have different non-zero numbers of sub-channels assigned to each antenna even though it is not PAR optimal. For example, some transmission channels 5 may have a much poorer quality than others. In this instance some poor performing channels 5 may be constrained to have fewer sub-channels 3 than other better performing channels 5.

The assignment of sub-channels 3 to transmission channels 5 by the allocation module 11 is an optimization problem which can be solved using algorithms known in the art.

In one particular embodiment the optimization problem is solved by using the values of the performance (or utility) measures to create a cost matrix. Each element in the cost matrix designates a cost of assigning a given sub-channel to a given transmission channel. The optimization problem may be defined as one of finding the desired allocation of sub-channels to transmission channels such as the total cost is minimized. This cost matrix is used to collect the performance measures for different alternative allocations, as an input to the optimization problem. In alternative embodiments a utility matrix may be used instead of a cost matrix. Each element of the utility matrix designates a benefit of assigning a given sub-channel to a channel.

The optimization problem may be maximizing or minimizing depending on the performance measure considered.

Consider an example of a system that uses OFDM sub-carriers as sub-channels. Let F denote a P×P fast Fourier transform (FFT) matrix, where [F]_{p,q}=1/P exp(−j2π(p−1)(q−1)/P). The inverse FFT (IFFT) matrix, applied at the OFDM transmitter is given by F^{†}, the Hermitian conjugate of F. We assume that the signal is transmitted through a finite impulse response (FIR) channel of length L and that a cyclic prefix of length L_{c}>L is used at the transmitter. Then, after removing the cyclic prefix, the effective signal model at the receiver is

y=FHF^{†}x+n, (1)

where H denotes a circulant convolution matrix with entries [H]_{p,q}=h((p−q)mod P), where h(l) designates the lth channel tap. Vector x represents the symbol vector and n complex Gaussian noise. Since FFT diagonalizes a circulant matrix, the model can be written also as

y=Dx+n, (2)

where D=(H(0), . . . , H(P−1)), with H(p)=Σₗ₌₀^{L}h(l)exp(−j2πlp/P). The concise model given above is given only as an example.

In this example, we have N transmit antennas, and each antenna is associated with a unique channel matrix H⁽ⁿ⁾, n=1, . . . , N. We assume, as an example, that each OFDM sub-carrier (column of F^{†}) is transmitted via only one of the N transmit antennas. The modified signal model is then given by

y=\tilde{D}x+n, (3)

where \tilde{D}=(H⁽ⁱ^{₀}⁾(0), . . . , H⁽ⁱ^{_{P-1}}⁾(P−1)), where iₚε{1, . . . , } is the index of the transmit antenna for sub-carrier p. We want to determine a sub-carrier-to-antenna allocation concept, which defines the indices {iₚ} appropriately.

If PAR reduction is the only target, we are content with random allocation, subject to the constraint the each antenna has an equal number of sub-carriers. On the other hand, if improved performance or capacity is the only target, a solution that assigns each sub-carrier to the antenna with largest power is desired. Then, we solve

$${i}_{p} = arg {max}_{m ∈ \{ 1 , … , \}} \{ {\vert {H}^{( m )} ( p ) \vert}^{2} \} , ∀ p = 0 , … , P - 1. \qquad ( 4 )$$

In posing this problem, we assume that the transmitter has obtained information pertaining to the channel powers {|H^{(m)}(p)|²}, ∀p,m, e.g. via a feedback channel (in conventional FDD) or with channel reciprocity (in TDD). Then, given channel state information, we may optimize capacity, received signal power, or some other performance metric. For the assignment problem the different performance metrics lead in general to different solutions. For the time being, we describe first the problem as one of maximizing received signal power. Analogously, we could maximize e.g. the sum of received signal-to-noise ratios, provided that the noise figure in each receiver is known to the allocation unit.

A solution that balances the PAR-optimal and performance-optimal solutions can be posed by formulating the problem as an assignment problem, or as a matching problem. For notational convenience, we define c_{m,p}={H^{(m)}(p)|²}, ∀p,m. Here c_{m,p} designates the ‘utility’ in assigning sub-carrier p to transmission antenna m, and these are captured in matrix C=[c_{m,p}]. The assignment problem for maximizing the total received signal power is posed as

$$\begin{matrix}max {\sum }_{p} {\sum }_{m} {c}_{m , p} {x}_{m , p} \\ subject to & ( 5 ) \\ {\sum }_{p} {x}_{m , p} = 1 , ∀ m & ( 6 ) \\ {\sum }_{m} {x}_{m , p} = 1 , ∀ p , & ( 7 ) \\ {x}_{m , p} \geq 0 , ∀ p , m . & ( 8 )\end{matrix}$$

The optimal solution is known to be integral, where x_{m,p}ε{0,1} where x_{m,p}=1 if iₚ=m, and x_{m,p}=0 otherwise. The constraints thus formalize the requirement that each sub-carrier is assigned to exactly one antenna and that all antennas are assigned exactly one sub-carrier. Different constraints may also be used, where the sums in equations (6)-(7) need not be equal to one but can be arbitrary non-negative real or integer numbers. In this case, the problem is called a transportation problem. This invention covers both cases, even if the description is focused on the assignment interpretation.

Typically the number of sub-carriers is much larger than the number of antennas. For example, in current WLAN (IEEE 802.11) systems P=64 and in recent OFDM proposals P=2048. On the other hand, the number of transmit antennas is typically 4-10. Thus, in most relevant cases P>N holds. However, in the traditional assignment problem the model should be square. When P>N the square model (assignment matrix) is constructed by creating virtual transmit antennas by copying certain rows of the utility matrix. The number of times a given row is copied determines the number of sub-carriers to be assigned to a given antenna.

Formally, this is accomplished by a matrix

\tilde{C}=Σeₖ [symbol] c_{A}_{_{k′}}_{:} (9)

where Aₖ is the index that indicates that the Aₖth row of matrix C (denoted as c_{A}_{_{k′}}_{:}) is inserted to the kth row of matrix \tilde{C}.

### Example

To demonstrate the tradeoff between maximizing utility and violating assignment constraints, consider a case where

$$C = [ \begin{matrix}1 & 2 & 3 \\ 6 & 8 & 9 \\ 4 & 3 & 1\end{matrix} ] \qquad ( 10 )$$

### and let A=[A₁, A₂, A₃]=[1,1,3]. Then,

$$\tilde{C} = [ \begin{matrix}1 & 2 & 3 \\ 1 & 2 & 3 \\ 4 & 3 & 1\end{matrix} ] . \qquad ( 11 )$$

Applying the assignment algorithm on this matrix leads to a solution where sub-carriers 2 and 3 are assigned to antenna 1, sub-carrier 1 to antenna 3, and zero sub-carriers are assigned to antenna 2. Here, due to the construction of A and thus \tilde{C}, no sub-carriers are allowed to be assigned to antenna 2. Given this constraint and resulting assignment, the total utility is 9, where the unconstrained solution to the original matrix C achieves utility of 23, and assigns all sub-carriers to antenna 2.

Complexity reduction may be needed since in converting the problem to a square matrix the problem dimension remains at P×P. Since the complexity of finding the optimal solution is a high order polynomial (approximately 4^{th} order polynomial, depending on the algorithm), it is important to determine approximate solutions by defining and solving approximate models of lower dimensionality.

The approximation has to be defined so that the performance or capacity loss remains tolerable. A viable approximate solution can be obtained by utilizing the channel correlations between different, e.g. neighboring sub-carriers (using channel coherence bandwidth in OFDM systems). Using this, we may form a (possibly weighted) average of the values of the utilities of T neighboring sub-carriers. This may be implemented e.g. by defining a matrix

U=I_{P/T} [symbol] l_{T} (13)

and forming a reduced dimensional model

C̅←U^{T}\tilde{C}U (14)

If the T neighboring values of the utility matrix are similar, the performance loss is marginal. On the other hand, by reducing the problem dimensionality e.g. by a factor of 4, the complexity may be reduced by a factor of 256 or more.

In practice, T≦P/N if a symmetric averaging is used (same averaging window over row and column dimensions), as in (14). This upper limit assumes that all antennas have essentially independent channels. It may be increased if the antennas are correlated, e.g. if structured antenna arrays are used, such as a Uniform Linear Array. In addition, T should be small enough so that averaging is performed within coherence bandwidth.

Here, the assignment is made for T sub-carriers simultaneously and thus in place of assigning individual sub-carriers, we assign multiple sub-carriers simultaneously to the same antenna. Furthermore, above it is assumed that all channels have similar time coherence and antenna assignment constraints, and are thus treated similarly. Alternatively, the dimension reduction may be applied only in frequency dimension (column dimension) and only for certain rows (antennas). For example, if one antenna can be assigned only one sub-carrier, the corresponding row of the matrix may be averaged only in row dimension. Thus, more generally the averaging is implemented with different averaging over the antenna dimension and different averaging over the frequency (sub-carrier) dimension, using U₁^{T}CU₂, where U₁ designates the averaging in antenna dimension with possibly different number of (consecutive) non-zero values in each column, and similarly for U₂. The mapping of the assignment based on C̅ may be easily recursed back to original antenna indices.

Alternative ways of reducing problem dimensionality clearly exist, e.g. decimating the matrix, use of median in place of average, etc. Essentially, any method that replaces a sub-matrix of \tilde{C} with a scalar in a meaningful way reduces the computational burden. Such reduction methods are not restricted to any particular performance measure used to form matrix C.

### Numerical Example

Consider an example related to a system where a cyclic effective channel matrix is formed using OFDM signaling, with either cyclic prefix or with zero-padding. The time response of channel l is represented by the vector h. If the channel coefficients for three lags are 1 2 3 then h=[1,2,3] which represents the channel temporal impulse response for one transmission channel.

The matrix H is the “equivalent channel matrix” or cyclic convolution channel matrix, formed by known means e.g. by removing the cyclic prefix from the received signal. The receiver sees for a block of 8 symbols.

$$H = [ \begin{matrix}1 & 0 & 0 & 0 & 0 & 0 & 3 & 2 \\ 2 & 1 & 0 & 0 & 0 & 0 & 0 & 3 \\ 3 & 2 & 1 & 0 & 0 & 0 & 0 & 0 \\ 0 & 3 & 2 & 1 & 0 & 0 & 0 & 0 \\ 0 & 0 & 3 & 2 & 1 & 0 & 0 & 0 \\ 0 & 0 & 0 & 3 & 2 & 1 & 0 & 0 \\ 0 & 0 & 0 & 0 & 3 & 2 & 1 & 0 \\ 0 & 0 & 0 & 0 & 0 & 3 & 2 & 1\end{matrix} ]$$

Vector h, or here its transpose, appears on each column, except wrapped for the last two columns, to make the matrix circular. Such a construction for the equivalent channel matrix appears e.g. in current Wireless LAN networks (although the dimension is there 64 not 8), and the transmitter and receiver operations that lead to such matrices are known in the art. The columns of H may be used as performance measures of different transmitted symbols (coordinates of vector x), although preferably we form a performance measure for symbols using all matrix elements, as follows.

The cost matrix C is formed from the diagonal values of FHF^{†} where F is a Fourier transform matrix. For example, with 8 sub-carriers. F is the 8×8 FFT matrix,

$$F = 1 / \sqrt{8} [ \begin{matrix}x & x & x & x & x & x & x & x \\ x & y - yi & - xi & - y - yi & x & - y + yi & xi & y + yi \\ x & - xi & - x & xi & x & - xi & x & xi \\ x & - y - yi & xi & y - yi & x & y + yi & - xi & - y + yi \\ x & - x & x & - x & x & - x & x & - x \\ x & - y + yi & - xi & y + yi & - x & y - yi & xi & - y - yi \\ x & xi & - x & - xi & x & xi & - x & - xi \\ x & y + yi & xi & - y + yi & - x & - y + yi & - xi & y - yi\end{matrix} ]$$

where x=1.0000 and y=0.7071, with 1/sqrt(8) used to normalize the transmission power of each sub-carrier to one,
and computing

$$D = {FHF}^{†} = [ \begin{matrix}A & 0 & 0 & 0 & 0 & 0 & 0 & 0 \\ 0 & B & 0 & 0 & 0 & 0 & 0 & 0 \\ 0 & 0 & C & 0 & 0 & 0 & 0 & 0 \\ 0 & 0 & 0 & D & 0 & 0 & 0 & 0 \\ 0 & 0 & 0 & 0 & E & 0 & 0 & 0 \\ 0 & 0 & 0 & 0 & 0 & F & 0 & 0 \\ 0 & 0 & 0 & 0 & 0 & 0 & G & 0 \\ 0 & 0 & 0 & 0 & 0 & 0 & 0 & H\end{matrix} ]$$

### Where

### A=6.0000

### B=2.4142−4.4142i

### C=−2.0000−2.0000i

### D=−0.4142+1.5858i

### E=2.0000

### F=−0.4142−1.5858i

### G=−2.0000+2.0000i

### H=2.4142+4.4142i

The square of the modulus of these values (|A|², |B|² . . . |H|²) designates the received powers for each of the eight sub-carriers for the particular transmission channel. The vector (|A|², |B|² . . . |H|²) then is placed on a the first row of the cost matrix C. Similarly, for a second transmission channel (say, the channel between transmission antenna 2 and the receiver) a physical channel is typically different from the H used above and therefore a different set of numbers (|A|² , |B|² . . . |H|²) arises.

For each different H (neglecting the channel index for simplicity) we add a row to the cost matrix C. For example, the second channel takes values h=[2,3,1], the cost matrix with two rows is

$$C = [ \begin{matrix}36.00 & 25.3137 & 8.0000 & 2.6863 & 4.0000 & 2.6863 & 8.00 & 25.3137 \\ 36.00 & 26.7279 & 10.00 & 1.2721 & 0 & 1.2721 & 10.00 & 26.7279\end{matrix} ]$$

The utility is defined in this example as the received power (|A|², |B|² . . . |H|²) for allocating different sub-channels (sub-carriers) to different transmission channels (antennas).

If the number of transmission channels (beams, antennas) is less than the number of sub-carriers, the matrix C is not square. However, in order to use certain assignment algorithms the cost matrix must be square. As shown above, a square matrix may be obtained by copying certain rows of the cost matrix thus creating virtual antennas. The number of times a row is copied determines the number of sub-carriers to be assigned to a given antenna. In this invention, the number may be different for different transmission channels, so that some rows of the cost matrix may be copied more often than other rows.

With equal allocation each row is copied equal number of times and the model cost matrix is then

$$\tilde{C} = [ \begin{matrix}36.0000 & 25.3137 & 8.0000 & 2.6863 & 4.0000 & 2.6863 & 8.0000 & 25.3137 \\ 36.0000 & 25.3137 & 8.0000 & 2.6863 & 4.0000 & 2.6863 & 8.0000 & 25.3137 \\ 36.0000 & 25.3137 & 8.0000 & 2.6863 & 4.0000 & 2.6863 & 8.0000 & 25.3137 \\ 36.0000 & 25.3137 & 8.0000 & 2.6863 & 4.0000 & 2.6863 & 8.0000 & 25.3137 \\ 36.0000 & 26.7279 & 10.0000 & 1.2721 & 0 & 1.2721 & 10.0000 & 26.7279 \\ 36.0000 & 26.7279 & 10.0000 & 1.2721 & 0 & 1.2721 & 10.0000 & 26.7279 \\ 36.0000 & 26.7279 & 10.0000 & 1.2721 & 0 & 1.2721 & 10.0000 & 26.7279 \\ 36.0000 & 26.7279 & 10.0000 & 1.2721 & 0 & 1.2721 & 10.0000 & 26.7279\end{matrix} ]$$

Above, antennas may be virtual antennas (copied rows) or actual antennas. All copied rows refer to the actual antenna indices. For example, row two is virtual antenna 2, but it refers to the actual antenna 1.

The cost matrix C is used to allocate the sub-channels to the transmission channels. The matrix C is used as an input to any mathematical programming algorithm that solves equations of type (5)-(8). A solution to the example is given by assignment indices 1 5 6 2 3 4 7 8 for which the values of the assignment matrix is

$$X = [ \begin{matrix}1 & 0 & 0 & 0 & 0 & 0 & 0 & 0 \\ 0 & 0 & 0 & 1 & 0 & 0 & 0 & 0 \\ 0 & 0 & 0 & 0 & 1 & 0 & 0 & 0 \\ 0 & 0 & 0 & 0 & 0 & 1 & 0 & 0 \\ 0 & 1 & 0 & 0 & 0 & 0 & 0 & 0 \\ 0 & 0 & 1 & 0 & 0 & 0 & 0 & 0 \\ 0 & 0 & 0 & 0 & 0 & 0 & 1 & 0 \\ 0 & 0 & 0 & 0 & 0 & 0 & 0 & 1\end{matrix} ]$$

Here X is a permutation matrix that solves equation (5) and the solution states that first sub-carrier is assigned to antenna 1, second sub-carrier to antenna 5, and so on. A solution to the problem (5) may be sought by exhaustively trying all possible permutations of number 1, . . . , 8, each associated with an assignment matrix X, as above, and selecting the matrix that yields highest value for equation (5). The number of all permutations for 8 digits is 8!=40320, and thus going through all solutions is computationally very demanding. However, the assignment may be found via much more effective computational methods, which can be found from mathematical programming literature. Examples of particular efficient algorithms for both the assignment and the transportation problem may be found e.g. from section 1.3.5 of G. L. Nemhauser and L. A. Wolsey, Integer and combinatorial optimization, John Wiley & Sons, 1999 or Chapter 8 in Applied Mathematical Programming by Bradley, Hax, and Magnanti (Addison-Wesley, 1977), available online from http://web.mit.edu/15.0531www/

We note that the assignment form of the problem is an example, and problems where the row constraints are not necessarily equal to one can also be used according to the invention. This corresponds to a generalization of the assignment problem, the generalization known in optimization literature under the name transportation problem, with numerical solutions vast in the literature, as described and referenced above.

Methods such as complexity reduction described above may be used to reduce the dimensions of the cost matrix and simplify the problem. When reducing the dimensions of a matrix it is assumed that more than one sub-carrier is allocated to the same antenna. Here, as an example, we may take sum together 2×2 sub-matrices and form a reduced dimensional matrix

$$\dot{C} = [ \begin{matrix}61.3137 & 10.6863 & 6.6863 & 33.3137 \\ 61.3137 & 10.6863 & 6.6863 & 33.3137 \\ 62.7279 & 11.2721 & 1.2721 & 36.7279 \\ 62.7279 & 11.2721 & 1.2721 & 36.7279\end{matrix} ]$$

An assignment solution (solved as above) for this matrix would be 4,1,2,3 where, using the knowledge of the 2×2 sub-matrices used in forming the averages, we know that sub-carriers 1,2, and 3,4, and 5,6, and 7,8 form sub-channels that include each two (here, neighboring) sub-carriers. Similarly, in the row dimension, we know that in the cost matrix with virtual antennas, rows 1-4 correspond to antenna or transmit path 1 and rows 5-8 to antennas or transmit paths 2. For the reduced dimensional matrix (with 2×2 averaging matrices) rows 1 and 2 correspond to transmit path or antenna 1, and correspondingly, rows 3 and 4, to antenna or transmit path 2, respectively.

Once the allocation module 11 has allocated the sub-channels 3 to respective channels 5 the set of sub-channels 3 is divided into subsets 3a, 3b . . . where each sub-set comprises the sub-channels that have been assigned to a given antenna 5. The sub-sets of sub-channels are amplified by the respective power amplifier 13 before being input to the connected antenna 5. The antennas then transmit a signal 15 comprising its allocated sub-channels.

The signals are received by the receiving units 7. A single receiving unit 7 may receive sub-channels transmitted by more than one antenna 5

In other embodiments a subset of transmission channels or sub-channels may be assigned to different users or to different destination nodes (e.g. relay nodes). Each user is a network node or terminal, or the network resources that are used to convey the information to the terminal or the node in the network. This corresponds to the case where certain rows of the cost matrix are computed for transmission channels between the transmitter and receiver 1 and transmitter and receiver 2. In one embodiment, the number of channels and thus the number of rows on the cost matrix increases in proportion to the number of receivers.

In the example above, sub-channels are defined and thus transmitted at different frequencies (sub-carriers). However, a sub-channel may be defined also as a different transmission time and then the assignment is interpreted as temporal scheduling. The transmit power, rate modulation and coding for each sub-channel may be controlled depending on the performance measure used to allocate sub-channels. Each user may have its own control means which can control the power and scheduling.

Further applications are possible. For example, the function c may include any effects modulation, coding, power allocation, beam forming etc. . . . The assignment (including any allocation or transportation problem variant) problem may be solved in manner that guarantees that all sub-channels get similar performance (e.g. we may find 3 best assignments and select the one that gives the highest utility for a given row or column of C, or a solution that is still closer to a minimax solution that maximizes the minimum of marginal c_{i,j}s, etc (i.e to include performance fairness in addition to PAR fairness. The solution may be sought as a minimization, when the target is minimize transmit power for given QoS target, or when the target is to find an assignment that minimizes some selected error measure (e.g. Bit-error-rate).

Moreover, with linear pre-coding the signal is made intentionally quasi-orthogonal, the IFFT matrix F is replaced by a matrix FT, where T is a pre-coding matrix, typically a unitary or a pseudo-unitary matrix. Pre-coding distributes the information symbols across multiple sub-carriers and in doing that creates transmitter-induced interference between symbols in frequency-selective channels. Then, the diagonal model (1) is general not valid.

A similar model arises with Multi-carrier-CDMA systems where the pre-coding matrix is specified typically with a matrix containing spreading codes. Applications to such systems are thus also within the scope of the invention.

However, it is possible to construct an approximate diagonal model in which the pre-coded symbols for one virtual communication channel. Indeed, in the OFDM case the equivalent signal model becomes

y=T^{†}DTx+n, (15)

and the matrix R=T^{†}DT typically has symbol subsets that interfere only with other symbols within the same subset, and are orthogonal to symbols in other subsets. For example, if T is a unitary matrix that has K non-zero elements in each row and column, the number of orthogonal subsets is P/K and each subset carries K symbols. The signal model with a given subset is of the form

y=Rx+n, (16)

where R has at least one non-zero element above the diagonal.

For such models, we may e.g. by constructing a common utility for symbol subsets by defining an equivalent channel signal-to-noise ratio each subset e.g. using an approximation to the error probability or signal-to-noise ratio. As an example, assuming the receiver user filter L within the subset a simple performance estimate can be obtained by invoking the Gaussian approximation using coefficients

γ_{k′,j}=(L^{†}R)_{k′,j},

$${β}_{{k}^{′}} = \frac{{( {L}^{†} R )}_{{k}^{′} , {k}^{′}}}{σ \sqrt{{( {L}^{†} RL )}_{{k}^{′} , {k}^{′}}}} , \\ and$$

$${λ}_{k}^{2} = \frac{{β}_{k}^{2} {\sum }_{j \neq {k}^{′}} {γ}_{{k}^{′} , j}^{2}}{{γ}_{{k}^{′} {k}^{′}}} ,$$

where k′ is the index for symbols within a symbol subset of interest (to be computed eventually for all subsets). Using these notations, a computationally attractive and accurate approximation to the average error probability for the symbol subset is given by

$${P}_{b} = \frac{1}{{K}^{′}} {\sum }_{{k}^{′} = 1}^{{K}^{′}} Q ( \frac{{β}_{{k}^{′}}}{\sqrt{1 + {λ}_{{k}^{′}}^{2}}} ) . \qquad ( 17 )$$

The fraction γ_{k′,j}/γ_{k′,k′} quantifies interference leakage between the k′th and jth stream. This vanishes for the decorrelating detector, λ_{k′}²=0, ∀k′. The signal-to-noise-ratio (SNR) approximation is

$${SNR}_{{k}^{′}} = \frac{{β}_{{k}^{′}}^{2}}{1 + {λ}_{{k}^{′}}^{2}} . \qquad ( 18 )$$

The average SNR within symbol subset

SNR=ΣSNR_{k′} (19)

may be used as the common performance measure and used thereafter to form the assignment matrix C for symbol (sub-carrier) clusters. As an example, the cost matrix may be defined as C=[SNR_{m,k}], k=1, . . . , P/K, m=1, . . . , if the sum of SNRs is of interest. Similarly, C=[−Q(\sqrt{SNR_{m,k}})], k=1, . . . , P/K, m=1, . . . , if an allocation that achieves minimum bit-error-rate is of interest, C=[10 log₁₀(1+\sqrt{SNR_{m,k}})], k=1, . . . , P/K, m=1, . . . , if total (Shannon) capacity is to be maximized, and so on. Moreover, the allocation matrix may be defined using outage-based criteria, e.g. the allocation unit may determine the probabilities that elements of matrix C are above or below given thresholds. For example, in a random channel the SNR is random, and the allocation unit may try to maximize the probability that good channels (e.g. SNR above threshold) are assigned. Such outage-based criteria are useful when the channel realizations are uncertain, or where the allocation unit is not able to control the assignment with sufficient accuracy.

These are just examples. Alternative ways of computing the capacity for different allocations are clearly possible.

The (possibly non-square) cost matrix C has then different number of columns and rows, and methods described above for converting the possibly non-square cost matrix to square matrix of desired dimension may be applied. Pre-coding is thus yet another complexity reduction method for the assignment problem as the column dimension of the assignment matrix reduces by a factor of K. The sub-carriers that are combined in the transmitter (using pre-coding) and need not be consecutive sub-carriers.

As an introduction to another example of a quasi-orthogonal system, where the approximations are valid write the sub-channel arising from sub-channel/sub-carrier selection operation as

Fₗ=F(0, . . . , 1,0, . . . , 0), (20)

where the number 1 is at lth diagonal position of the RHS matrix (zeros elsewhere), and F is the IFFT matrix. Then, the sub-carrier-antenna assignment may be described as a means to select matrix Fᵢ_{ᵤ} (forming a part of transmission matrix Xᵤ)

X(u,iᵤ)=Fᵢ_{ᵤ}xᵤ

for each symbol stream xᵤ. The received signal for stream u,

Y(u)=X(u,iᵤ)Hᵤ+nᵤ

where it is assumed that the channel H may be different for each u. A modulation matrix of this form is a particular case only.

With MIMO modulation Xᵤ(u,iᵤ) has a larger number of alternatives to choose from, but then also we try to select iᵤs for each u given the performance measures that are derived using knowledge of Hᵤ or HᵤWᵤ where W is a beam-forming matrix.

In the multi-antenna modulator matrices, each subcarrier or subchannel may be transmitted over multiple antennas, time slots etc. and the indexes may refer to time slots in place of sub-carriers. The problem is then not one of sub-carrier-antenna assignment but sub-channel transmit path assignment. However, here also, the transmitter has more than one transmit antenna and interference prevails between symbols. Pre-coded OFDM is one example of transmission scheme that induces intentional interference between symbols and performance measured derived for such channels may be reused here.

As an example, consider a block transmission method using waveform basis matrices F and G.

Typically (but not restricting the invention in any way), as described above, in OFDM systems F is an IFFT matrix, and G=F*, i.e. comprising conjugated entries of F. The basis matrices are augmented with cyclic prefix (zero padding may be used alternatively) by making sure that the first L rows are identical to the last L rows, where L is the length of the FIR channel. In single-carrier transmission we may set F=I and G=P, where P is reversal matrix of appropriate dimension (ones in the anti-diagonal, zeros elsewhere). The system load is defined by the proportion of columns taken from F and G. Zero-padding and/or cyclic prefixing may be modelled in a known way.

Alternative block transmission matrices may naturally be used, e.g. those using spreading codes, pre-coded IFFT matrices, random or scrambled spreading codes, etc.

As an example of a MIMO system using sub-channels, a MIMO modulator could read e.g. as

$${X}_{iABBA} = [ \begin{matrix}{Fx}_{1} & {Gx}_{2}^{*} & {Fx}_{3} & {Gx}_{4}^{*} \\ {Fx}_{2} & - {Gx}_{1}^{*} & {Fx}_{4} & - {Gx}_{3}^{*} \\ {jFx}_{3} & {jGx}_{4}^{*} & {Fx}_{1} & {Gx}_{2}^{*} \\ {jFx}_{4} & - {jGx}_{3}^{*} & {Fx}_{2} & - {Gx}_{1}^{*}\end{matrix} ] + [ \begin{matrix}{Fx}_{5} & {Gx}_{6}^{*} & {Fx}_{7} & {Gx}_{8}^{*} \\ {Fx}_{6} & - {Gx}_{5}^{*} & {Fx}_{8} & - {Gx}_{7}^{*} \\ {jFx}_{7} & - {jGx}_{8}^{*} & - {Fx}_{5} & - {Gx}_{6}^{*} \\ {jFx}_{8} & {jGx}_{7}^{*} & - {Fx}_{6} & {Gx}_{5}^{*}\end{matrix} ] \qquad ( 21 )$$

where columns are transmitted over different transmit paths (e.g. beams or antennas). Naturally, these MIMO modulation matrices may be defined in alternative ways, where the matrix elements may be in different orthogonal dimensions (e.g. some symbols or sub-matrices may be separated in time and some in frequency/code as in space-time-frequency modulation) and the performance measures may be computed in an analogous way then.

The MIMO modulation matrix may be used e.g. in one of P sub-carriers (by selecting one column of F matrix) and performance or utility measure defines the value for the utility matrix when the given modulator is used over a given subset of beams or antennas. The antenna or beam indices may be arbitrary, and in defining the cost matrix the column may correspond to some indexed set of ways of selecting subsets of antennas from N antennas for use with sub-carrier p. The matrix may be computed for a desired number of sub-carrier or for all P sub-carriers. If the number subsets is smaller than the number of sub-carriers or waveforms, virtual antenna subsets may be formed by repeating selected columns, in analogy with the way virtual antennas were formed above.

This does not necessarily mitigate the PAR problem but results in optimal scheduling of signals to different antenna subsets and frequencies.

For a multi-user case e.g. using OFDMA, two columns of F(and G) are for communicating with two different receivers. In uplink, we may in one extreme case have e.g. P users and each user is allocated only one sub-carrier (one column), while at least one users has at least two transmit antennas. If we take the modulator (21), the signal transmitted at sub-carrier n by user u is

X_{iDb}(u,iᵤ)=X_{iDbl}(u,iᵤ)+X_{iDb2}(u,iᵢ), (22)

where the model is the same as in (21) except that F and G matrices are replaced by their corresponding iᵤth columns. The signal received at base station is

ΣX(u,iᵤ)Hᵤ+n (23)

where iᵤ is the sub-carrier assigned to user u and Hᵤ is the MIMO channel between the uth user and the receiver.

The assignment may be computed by computing the utility matrix entry using a performance value for each model [X_{iDb}(u,iᵤ)Hᵤ+n], u=1, . . . , P; n=1, . . . , P as described above in connection with interference channels. In particular, each X_{iDb}(u,iᵤ)Hᵤ+n may be converted to a form (16) and thereafter numerous performance estimates may be computed—to be inserted to C matrix for use in optimizing the allocations.

Naturally, the matrix dimensionality may be here reduced and more than one sub-carrier may be assigned to users, different number of sub-carriers may be assigned to different users. The sub-carrier may be allocated in subsets so that a common performance measure is computed for the subset.

A similar model arises in downlink, where the sub-carrier allocation unit computed the sub-carrier (or sub-carrier subset) index for each spatially separate receiver.

Thus, the proposed method can be used also for multiple access purposes. The assigned sub-carrier indices may need to be signaled to the receiver and the transmitter from the allocation unit.

It is highlighted that the use of terms sub-carrier or antenna are not restrictive in any way, and throughout these words may be replaced by alternative sub-channels, or beams, respectively.

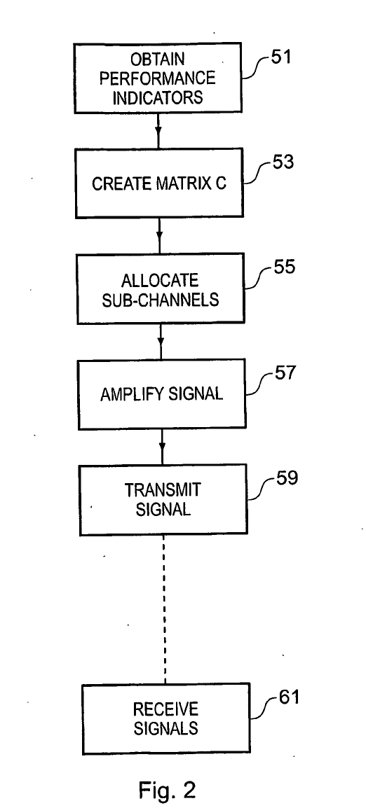

FIG. 2 illustrates the steps of the method of the allocation of the sub-channels 3 to the transmission channels 5. Steps 51 to 59 occur at the transmitter unit 9. Step 61 occurs at the receiving unit 7.

At 51 the allocation module obtains performance measures of the system. Then at 53 these measures are used to create the cost matrix. The allocation module uses the cost matrix to allocate 55 the sub-channels 3 to the transmission channels 5 subject to constraints on the number of sub-channels 3 assigned to each transmission channel 5.

The sub-channels 3 are amplified 57 by the power amplifiers 13 before being transmitted by the antennas 5. The signals 15 transmitted by the antennas are received 61 by the receiving units.

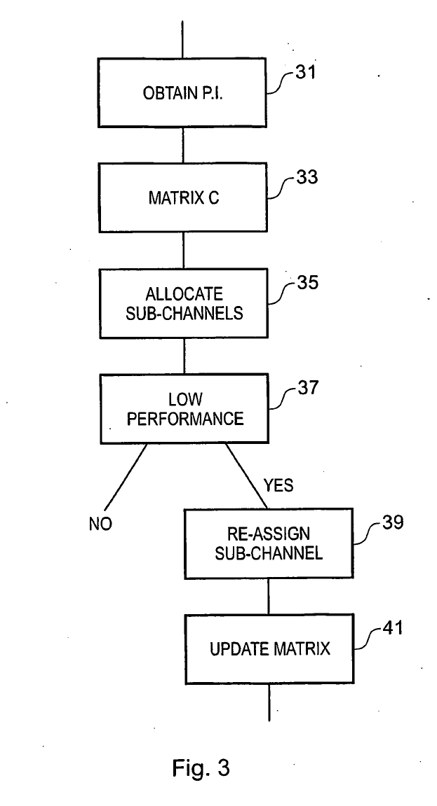

FIG. 3 illustrates a second embodiment of the invention.

In this embodiment the allocation module obtains 31 performance measures which may include information about how the performances of the channels vary with time. These performance measures are used to create 33 a cost matrix where each element relates to the performance of a given sub-channel when assigned to a given channel.

In this embodiment all of the transmission channels are used, however in other embodiments only a subset of transmission channels are used. In some embodiments only a subset of the sub-channels may be used at any given time.

The allocation module then at an allocation interval initially assigns 35 the sub-channels to the transmission channels.

Preferably the cost matrix is used to assign the sub-channels to the transmission channels. There may be constraints upon the number of channels which are assigned to each transmission channel.

Then, between or during allocation intervals, performance measures are used to determine 37 if any of the assigned sub-channels have a poor performance indicator in the channel to which they have been assigned. “Donor” channels with poor performance indicators have some of their sub-channels reassigned 39 to channels with higher performance indicators.

The cost matrix is then updated 41 so that any donor channels are given a higher priority for the next allocation interval. The cost matrix has memory and the process is repeated for every allocation interval so that even if a channel has a low performance measure its priority will increase with every allocation interval so that it is not always a donor channel.

Allocation may take place whenever a sub-channel is added or whenever the cost matrix changes substantially. Allocation intervals occur whenever it is possible to change the assignments in the system. Preferably the time between allocation intervals is smaller than the time in which the performance measures of the channels can change substantially.

Although embodiments of the present invention have been described in the preceding paragraphs with reference to various examples, it should be appreciated that modifications to the examples given can be made without departing from the scope of the invention as claimed.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

What is claimed is:

1. A method of allocating a set of sub-channels to a plurality of transmission channels in a multi transmission-channel system comprising; mapping a first, non-zero, set of sub-channels to a first transmission channel; mapping a second, non-zero, set of sub-channels to a second transmission channel, wherein at least one sub-channel of the first set and at least one sub-channel of the second set are allocated to one receiving unit.

2. The method as claimed in claim 1, wherein the number of sub-channels assigned to each of the plurality of transmission channels is constrained.

3. The method as claimed in claim 2, wherein one of the constraints is a limit on the number of sub-channels which can be assigned to any one transmission channel.

4. The method as claimed in claim 2, wherein one of the constraints is that some transmission channels are allocated fewer sub-channels than others.

5. The method as claimed in claim 1, wherein the sub-channels are allocated to the transmission channels so as to optimise a performance indicator of the multi transmission-channel system.

6. The method as claimed in claim 5, wherein values of the performance indicator of the transmission channel are obtained by the transmitter.

7. The method as claimed in claim 5, wherein the performance indicator can include the throughput, the signal noise ratio, the transmitted power required for a given quality of service, or an error measure.

8. The method as claimed in claim 1, wherein the sub-channels are allocated to the transmission channels by solving an optimisation problem.

9. The method as claimed in claim 1, wherein the multi transmission-channel system is an OFDM or OFDMA system.

10. The method as claimed in claim 1, wherein a sub-channel is a waveform used to differentiate different streams of symbols or information.

11. The method as claimed in claim 1, wherein the waveform is an OFDM sub-carrier, wavelet, spreading code, time slot, or a combination of thereof.

12. The method as claimed in claim 1, wherein the transmission channel is an antenna or a radiation pattern or a transmission beam or a modulation matrix.

13. The method as claimed in claim 12, wherein each different transmission channel has at least one of radiation pattern(s), beams(s), modulation matrix, modulation method, transmission power, or combination thereof, different to those of another transmission channel.

14. The method as claimed in claim 1, wherein a performance indicator is computed for different transmission channels and for different sub-channels.

15. The method as claimed in claim 1, wherein at least two sub-channels have different physical channels to the receiver.

16. A node in a telecommunications network comprising:
an allocation module for allocating a set of sub-channels to a plurality of transmission channels in a multi transmission-channel system, the allocation module configured:
for mapping a first, non-zero, set of sub-channels to a first transmission channel; and
for mapping a second, non-zero, set of sub-channels to a second transmission channel, wherein at least one sub-channel of the first set and at least one sub-channel of the second set are allocated to one receiving unit.

17. A computer readable medium stored with program instructions for controlling the allocation of a set of sub-channels to a plurality of transmission channels in a multi transmission-channel system which, when executed by a processor, provide for:
mapping a first, non-zero, set of sub-channels to a first transmission channel; and
mapping a second, non-zero, set of sub-channels to a second transmission channel, wherein at least one sub-channel of the first set and at least one sub-channel of the second set are allocated to one receiving unit.

18. (canceled)

19. (canceled)

20. A method of allocating a set of sub-channels to a plurality of transmission channels in a multi transmission-channel system comprising;
mapping a first, non-zero, set of sub-channels to a first transmission channel,
mapping a second, non-zero, set of sub-channels to a second transmission channel, wherein the sub-channels are assigned to the transmission channels to optimise a performance indicator of the multi transmission-channel system.

21. A node in a telecommunications network comprising:
an allocation module for allocating a set of sub-channels to a plurality of transmission channels in a multi transmission-channel system, the allocation module configured:
for mapping a first, non-zero, set of sub-channels to a first transmission channel; and
for mapping a second, non-zero, set of sub-channels to a second transmission channel, wherein the sub-channels are, assigned to the transmission channels to optimise a performance indicator of the multi transmission-channel system.

22. A computer readable medium stored with program instructions for controlling the allocation of a set of sub-channels to a plurality of transmission channels in a multi transmission-channel system which, when executed by a processor, provides:
for mapping a first, non-zero, set of sub-channels to a first transmission channel; and
for mapping a second, non-zero, set of sub-channels to a second transmission channel, wherein the sub-channels are assigned to the transmission channels to optimise a performance indicator of the multi transmission-channel system.

23. (canceled)

24. A method comprising:
allocating each of a set of sub-channels to a plurality of transmission channels in a multi transmission-channel system, wherein each of the transmission channels of the multi transmission-channel system has at least one sub-channel assigned thereto.

25. A node in a telecommunications network comprising:
an allocation module for allocating each of a set of sub-channels to a plurality of transmission channels in a multi transmission-channel system, the allocation module configured:
for assigning at least one sub-channel to each of the transmission channels of the multi transmission-channel system.

26. A computer readable medium stored with program instructions for controlling the allocation of each of a set of sub-channels to a plurality of transmission channels in a multi transmission-channel system, which, when executed by a processor, provides for assigning at least one sub-channel to each of the transmission channels of the multi transmission-channel system.

27. (canceled)

28. A method of allocating a set of sub-channels to channels in a multi transmission-channel system comprising;
allocating the set of sub-channels to the transmission channels,
if a first sub-channel has an unsatisfactory performance indicator value when allocated to a first transmission channel, reassigning the first sub-channel to a second transmission channel with a satisfactory performance indicator, and
increasing the priority of the first channel for the next scheduling interval.

29. A node in a telecommunications network comprising:
an allocation module for allocating a set of sub-channels to channels in a multi transmission-channel system, the allocation module configured:
for allocating the set of sub-channels to the transmission channels;
for reassigning the first sub-channel to a second transmission channel with a satisfactory performance indicator, if a first sub-channel has an unsatisfactory performance indicator value when allocated to a first transmission channel; and
for increasing the priority of the first channel for the next scheduling interval.

30. A computer readable medium stored with program instructions for controlling the allocation of a set of sub-channels to channels in a multi transmission-channel system which, when executed by a processor, provide:
for allocating the set of sub-channels to the transmission channels;
for reassigning the first sub-channel to a second transmission channel with a satisfactory performance indicator, if a first sub-channel has an unsatisfactory performance indicator value when allocated to a first transmission channel; and
for increasing the priority of the first channel for the next scheduling interval.

31. (canceled)

32. A method of allocating a set of sub-channels to channels in a multi transmission-channel system using a utility/cost matrix comprising:
modifying the cost/utility matrix in at least one dimension; and
computing sub-channel allocations using the modified cost/utility matrix.

33. The method as claimed in claim 32, wherein modifying the cost/utility matrix comprises reducing the dimensionality of the matrix in two dimensions.

34. The method as claimed in claim 32, wherein modifying the cost/utility matrix comprises increasing the dimensionality of the matrix to create a square matrix.

35. The method as claimed in claim 34, wherein modifying the cost/utility matrix comprises increasing the dimensionality of the matrix by copying row(s)/column(s).

36. The method as claimed in claim 35, wherein modifying the cost/utility matrix comprises copying at least one element of the matrix more often than another element of the matrix.

37. The method as claimed in claim 32, further comprising computing a further sub-channel allocation using a different cost/utility matrix having a different dimensionality.

38. The method as claimed in claim 32, further comprising transmitting information relating to the sub-channel assignments to a transmitter and/or a receiver.

39. A node in a telecommunications network comprising:
an allocation module for allocating a set of sub-channels to channels in a multi transmission-channel system using a utility/cost matrix, the allocation module configured: for modifying the cost/utility matrix in at least one dimension; and
for computing sub-channel allocations using the modified cost/utility matrix.

40. A computer readable medium stored with program instructions for controlling the allocation of a set of sub-channels to channels in a multi transmission-channel system using a utility/cost matrix which, when executed by a processor, provide:
for modifying the cost/utility matrix in at least one dimension; and
for computing sub-channel allocations using the modified cost/utility matrix.

41. (canceled)

42. (canceled)

43. (canceled)
